(19) United States
(12) Patent Application Publication
(10) Pub. No.: US 2013/0166678 A1
(43) Pub. Date: Jun. 27, 2013

(54) Smart Suggestions Engine for Mobile Devices

(71) Applicants: Nimrod Barak, Tel Aviv (IL); Doron Lehmann, Kfar Vradim (IL); Eyal Nathan, Tel Aviv (IL)

(72) Inventors: Nimrod Barak, Tel Aviv (IL); Doron Lehmann, Kfar Vradim (IL); Eyal Nathan, Tel Aviv (IL)

(73) Assignee: SAP Portals Israel Ltd, Raanana (IL)

(21) Appl. No.: 13/337,517

(22) Filed: Dec. 27, 2011

(51) Int. Cl. G06F 15/16

(52) U.S. Cl. 709/217

(57) ABSTRACT

The disclosure generally describes computer-implemented methods, software, and systems for providing relevant content to a requesting mobile device that include receiving, using at least one computer, a request for enterprise portal application content; identifying a requesting device from the received request; identifying enterprise portal application content from at least one enterprise portal application associated with the received request; determining capabilities of the requesting device; and comparing the determined capabilities of the requesting device with the capabilities required by a particular enterprise portal application.

### TECHNICAL FIELD

The present disclosure relates to computer-implemented methods, software, and systems for providing relevant content to a requesting mobile device.

### BACKGROUND

In a world of great diversity in mobile devices, an organization providing applications to the mobile devices does not have full control over which mobile device can run certain applications and consume content that leverage those advanced capabilities. Mobile devices can include advanced capabilities that can enrich business applications, such as Camera, GPS, and others.

### SUMMARY

The disclosure generally describes computer-implemented methods, software, and systems for providing relevant content to a requesting mobile device. Specifically, a mobile device can request content from portal applications hosted on a server. The device can include (e.g., associated with) certain capabilities. For example, hardware capabilities such as a GPS and a camera; and software capabilities such as a web browser and operating system. Furthermore, the portal applications can be associated with (e.g., tagged) certain capabilities that the mobile device would need to run the particular portal application. Thus, the capabilities of the mobile device and the portal applications can be compared to determine matches between the mobile device and portal applications. Portal applications (and similarly, content) can be filtered (e.g., removed) from transmission to the mobile device such that the mobile device displays matched applications (and content). In some embodiments, non-relevant content can be filtered in response to a search result. In some embodiments, content can be prioritized based on the comparison.

A general embodiment implemented in methods, software, and systems for providing relevant content to a mobile device includes: receiving, using at least one computer, a request for enterprise portal application content; identifying a requesting device from the received request; identifying enterprise portal application content from at least one enterprise portal application associated with the received request; determining capabilities of the requesting device; and comparing the determined capabilities of the requesting device with the capabilities required by a particular enterprise portal application.

In a first aspect combinable with the general embodiment, the received request is from a mobile device.

In a second aspect combinable with any of the previous aspects, the received request contains data identifying the mobile device.

In a third aspect combinable with any of the previous aspects, the requesting device capabilities are determined using one or more self-contained web documents that each reference a Uniform Resource Locator (URL).

A fourth aspect combinable with any of the previous aspects includes identifying the relevance of the enterprise portal content to the requesting device based upon at least one result of the comparison.

A fifth aspect combinable with any of the previous aspects includes modifying the identified enterprise portal content based upon the comparison.

In a sixth aspect combinable with any of the previous aspects, the modification removes non-relevant content from the identified enterprise portal content.

In a seventh aspect combinable with any of the previous aspects, the modification prioritizes the identified enterprise portal content.

In an eighth aspect combinable with any of the previous aspects, the modification removes non-relevant content from the identified enterprise portal content, forming a relevant data subset, and then prioritizes the relevant data subset.

A ninth aspect combinable with any of the previous aspects includes transmitting the modified identified enterprise portal content to the requesting device.

While generally described as computer-implemented software embodied on a non-transitory computer readable storage device that processes and transforms respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example system for providing relevant content to a requesting mobile device;

FIG. 2 is a flowchart of an example method for providing relevant content to a requesting mobile device; and

FIG. 3 is a flowchart of an example method for providing smart suggestions for content to a requesting mobile device.

### DETAILED DESCRIPTION

The disclosure generally describes computer-implemented methods, software, and systems for providing relevant content to a requesting mobile device. In some embodiments, a mobile device can request content from portal applications hosted on a server. The device can include (e.g., associated with) certain capabilities. For example, hardware capabilities such as a GPS and a camera; and software capabilities such as a web browser and operating system. Furthermore, the portal applications can be associated with (e.g., tagged) certain capabilities that the mobile device would need to run the particular portal application. Thus, the capabilities of the mobile device and the portal applications can be compared to determine matches between the mobile device and portal applications. Portal applications (and similarly, content) can be filtered (e.g., removed) from transmission to the mobile device such that the mobile device displays matched applications (and content). In some embodiments, non-relevant content can be filtered in response to a search result. In some embodiments, content can be prioritized based on the comparison.

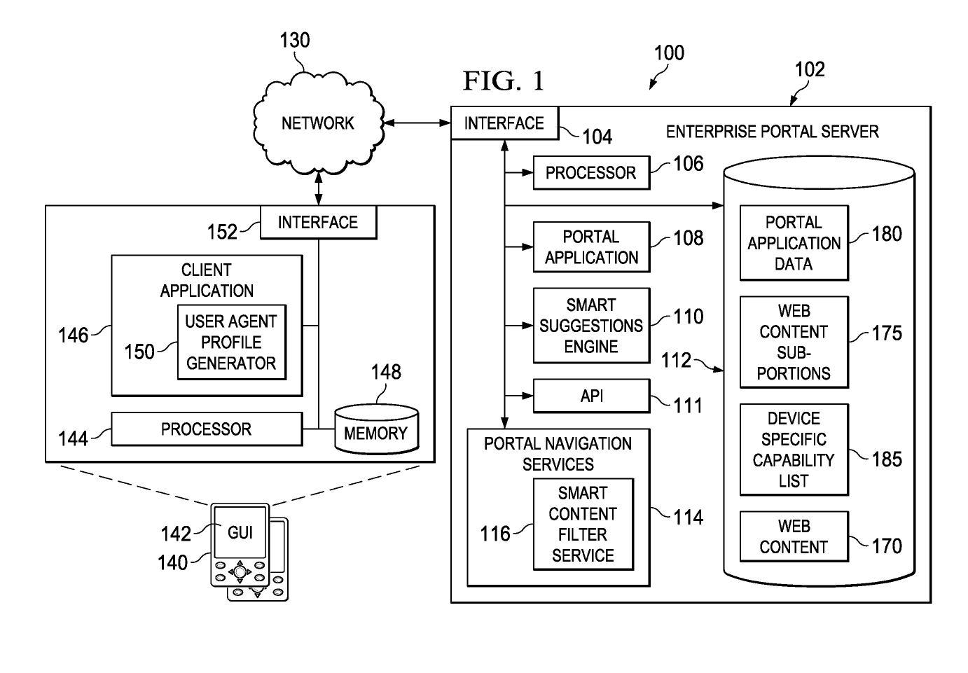

FIG. 1 illustrates an example distributed computing system 100 operable to provide relevant content to a requesting mobile device. Specifically, the illustrated environment 100 includes or is communicably coupled with an enterprise portal server 102 and a mobile communications device 140 (“mobile device”) that communicate across a network 130.

In general, the server 102 is a server that stores one or more portal applications 108, where at least a portion of the portal applications 108 are executed via requests and responses sent to users or clients within and communicably coupled to the illustrated environment 100 of FIG. 1. In some instances, the server 102 may store a plurality of various portal applications 108, while in other instances, the server 102 may be a dedicated server meant to store and execute only a single portal application 108. In some instances, the server 102 may comprise a web server, where the portal applications 108 represent one or more web-based applications accessed and executed via a network by the mobile device 140 to perform the programmed tasks or operations of the portal application 108.

At a high level, the server 102 comprises an electronic computing device operable to receive, transmit, process, store, or manage data and information associated with the environment 100. Specifically, the server 102 illustrated in FIG. 1 is responsible for receiving application requests from one or more client applications associated with the mobile device 140 of the environment 100 and responding to the received requests by processing said requests in the associated portal application, and sending the appropriate response from the portal application back to the requesting client application. In addition to requests from the mobile device 140, requests associated with the portal applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single server 102, environment 100 can be implemented using two or more servers 102, as well as computers other than servers, including a server pool. Indeed, server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system. According to one embodiment, server 102 may also include or be communicably coupled with a mail server.

The server 102 also includes an interface 104, a processor 106, and a memory 112. The interface 104 is used by the server 102 for communicating with other systems in a distributed environment—including within the environment 100—connected to the network 130; for example, the mobile device 140, as well as other systems communicably coupled to the network 130. Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated environment 100.

As illustrated in FIG. 1, the server 102 includes a processor 106. Although illustrated as a single processor 106 in FIG. 1, two or more processors may be used according to particular needs, desires, or particular embodiments of the environment 100. Each processor 106 may be a central processing unit (CPU), a blade, an application specific integrated circuit (ASIC), a field-programmable gate array (FPGA), or another suitable component. Generally, the processor 106 executes instructions and manipulates data to perform the operations of the server 102. Specifically, the processor 106 executes the functionality required to receive and respond to requests from the mobile device 140.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The server 102 also includes a memory 112, or multiple memories 112. The memory 112 may include any memory or database module and may take the form of volatile or non-volatile memory including, without limitation, magnetic media, optical media, random access memory (RAM), read-only memory (ROM), removable media, or any other suitable local or remote memory component. The memory 112 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102. Additionally, the memory 112 may include any other appropriate data, such as VPN applications, firmware logs and policies, firewall policies, a security or access log, print or other reporting files, as well as others.

The memory 112 includes web content 170, web content sub-portions 175, portal application data 180, and a device specific capability list 185. The web content 170 is the textual, visual or aural content that is encountered as part of the user experience on websites. The web content 170 may include, among other things: text, images, sounds, videos and animations. In some embodiments, the web content 170 can include an enterprise portal. An enterprise portal, also known as an enterprise information portal (EIP) or a corporate portal, is a framework for integrating information, people and processes across organizational boundaries. The enterprise portal provides a secure unified access point, often in the form of a web-based user interface, and is designed to aggregate and personalize information through application-specific portals. The enterprise portal is the de-centralized content contribution and content management, which keeps the information always updated. With only a Web browser, users can begin work once they have been authenticated in the portal which offers a single point of access to information, enterprise applications, and services both inside and outside an organization. Portals may present information from diverse sources in a unified way, and provide additional services, such as an internal search engine, e-mail, news, and various other features. Portals are often used by enterprises for providing their employees, customers, and possibly additional users with a consistent look and feel, and access control and procedures for multiple applications, which otherwise would have been separate entities altogether.

The illustrated web content sub-portions 175 are any kind of application, information, or service that can be visualized in a Web browser frame, such as, for example, an iView or other type of web content sub-portion. The web content sub-portions 175, in some embodiments, may be self-contained Web documents that are provided via a Uniform Resource Locator (URL) that are managed by the server 102. For example, the web content sub-portions 175 can include alerts, reports, email, calendar, and other content. For example, if a user enters a word in a dictionary web content sub-portion 175, the definition appears inside the area of the web content sub-portions 175. A link to usage examples, similar words, etc. can also be provided. In some embodiments, the web content sub-portions 175 are any application, information, or service that can be visualized in a Web browser frame appearing in a special container (e.g., a “tray”). The special container stores tagged capabilities of the associated portal applications 108, described further below. A developer or administrator can determine what capabilities are required by the web content sub-portions 175.

The illustrated web content sub-portions 175 can include one or more of the characteristics of: stateless (not permanently connected to any component of the environment 100); embedded (non-dominant, parallel to other web content sub-portions 175); provide previews on underlying processes and/or data; one-screen interactions; include only key functionality; provide direct access without navigation; push information and refresh periodically; integration with third-party software; and allow users to modify an appearance thereof. The web content sub-portions 175 may provide data, for example, providing active information; monitor business processes; preview data and processes; display notifications for starting task-related processes; and offering access to often used data. The web content sub-portions 175 may further provide direct access to simple applications; accelerated access to other applications; reduction of information and interaction to the necessary; and drag-and-relate that use outputs as inputs within the environment 100. The web content sub-portions 175 offer customization such that specific web content sub-portions 175, along with reduction of information and tailoring of information presented by the web content sub-portions 175, can be implemented according to user data associated with the user of the mobile device 140.

The illustrated portal application data 180 includes a listing of the portal applications 108 and the associated capability tags of the portal applications 108. The tags can indicate capabilities of the mobile device 140 required by the portal applications 108 to display (e.g., run or execute) the portal applications 108. For example, a particular portal application 108 can be associated with tags indicating that a global positioning system (GPS) capability and a browser version capability is needed to run the particular portal application 108 (e.g., receive content generated by the particular portal application 108). Thus, for the mobile device 140 to receive content from the particular portal application 108, the mobile device 140 includes (or associated with) the one or more tagged capabilities (e.g., the GPS capability, the browser version capability, or both). Each portal application 108 can be associated with one or more tags indicating required capabilities, and one or more portal applications 108 can be associated with one or more of the same tags.

In some embodiments, the capabilities required by the portal applications 108 are stored by the web content sub-portion 175 that “wraps” the particular portal application 108. In other words, the capabilities required by the portal applications 108 are stored by the web content sub-portion 175 for the particular portal application 108. For example, in some embodiments, data (e.g., metadata) may be stored on a database that describes a portal application 108 and also provides some additional characteristics. This web content sub-portion 175 may contain all the additional information necessary to maintain and run the portal application 108 in the context of the portal. In some embodiments, for example in the portal administration environment, an administrator can configure those properties to define how the application (or the web content sub-portion 175) will look and behave and runtime. The web content sub-portion 175 may also be added as a content object to the portal page (e.g., a combination of multiple web content sub-portions 175). The developer or administrator can determine the capabilities required by the portal applications 108 (e.g., the associated tags of the portal applications 108). For example, for a particular portal application 108 that requires the GPS capability (e.g., the portal application data 180 stores an association between the particular portal application 108 and the GPS capability), the web content sub-portion 175 that “wraps” the particular portal application 108 can include the “com.enterprise.portal.application.devicecapabilities” property.

The device specific capability list 185 includes a listing of devices (e.g., the mobile device 140) and associated capability tags of the devices. For example, when the mobile device 140 establishes a session with the server 102, the mobile device 140 transmits information regarding the mobile device 140 to the server 102, described further below. This information can include identifying information of the mobile device 140, including capabilities of the mobile device 140 (e.g., GPS, camera, browser version, operating system, etc.). In some embodiments, the device specific capability list 185 can include a history of the capabilities of each mobile device 140 that establishes a session with the server 102, and can include the history for any amount of time (e.g., 1 day, 1 month, 1 year, etc.). In some embodiments, after the expiration of the session between the mobile device 140 and the sever 102, the device-specific capabilities established during the session can be deleted from the device specific capability list 185. In some embodiments, the capabilities stored by the device specific capability list 185 can be stored with respect to each individual mobile device 140, or can be categorized for each type of mobile device 140.

The server 102 further includes portal navigation services 114. The portal navigation services 114. Generally, the navigation services 114 are responsible for the creation of the content hierarchy in the portal, and to provide all the additional services provided in the “shell” of the portal (e.g., searching capabilities, personalization, etc.). For example, the navigation services 114 may create a tree of navigation nodes for each user who enters the portal. Each node represents specific content, or a collection of content, that can be viewed by the user. For each user, the portal navigation services 114 is responsible for generating a navigation tree of links to the portal content assigned to the user. An application—for example, a client running on a user's machine or an application running in the portal—can query the navigation services 114 for the current user's navigation hierarchy or tree, and then display this tree to the user. Portal applications can query the navigation services 114 via a Java API. External applications can query the navigation services 114 via this Web service.

The portal navigation services 114 includes a smart content filter service 116. The smart content filter service 116 determines, for each mobile device (e.g., the mobile device 140), which content (e.g., content from the portal applications 108) can be displayed (e.g., run or executed) by the particular mobile device. Specifically, the smart content filter service 116 compares the associated tags of a particular portal application 108 stored by the portal application data 180 with received information from the mobile device 140 that includes the capabilities of the mobile device 140, described further below. Based on the comparison, the smart content filter service 116 can filter (e.g., remove) content (e.g., content from the portal applications 108) from display on the mobile device 140. Continuing the example above, the smart content filter service 116 can compare the capabilities of a particular portal application 108 including associated tags of GPS capabilities and browser version capabilities with received identification (e.g., capability) information of the mobile device 140. The smart content filter service 116 can maintain the content of the particular portal application 108 for display on the mobile device 140 (e.g., allow transmission of content of the particular portal application 108 to the mobile device 140) or filter (e.g., remove) the content of the particular portal application 108 from display on the mobile device 140 (e.g., disallow transmission of content of the particular portal application 108 to the mobile device 140).

The illustrated server 102 further includes a smart suggestions engine 110. The smart suggestion engine 110 can, in response to a search query from the mobile device 140, alter a search results listing by filtering (e.g., removing) search results related to content (e.g., content from the portal applications 108) based on the tagged capabilities of the content and the capabilities of the mobile device 140. Specifically, the smart suggestions engine 110 can apply the filtering of content as applied by the smart content filter service 116 to the search results listing, described further below. Continuing the example above, the smart suggestion engine 110 can filter (e.g., remove) search results from a search results listing based on the aforementioned comparison.

In some embodiments, the smart suggestions engine 110 can determine a matching score between the content (e.g., content from the portal applications 108) and the mobile device 140. The matching score can be based on the specific capabilities matched between the content and the mobile device 140, on an amount of matching capabilities between the content and the mobile device 140, and on other criteria. The smart suggestion engine 110 can alter the search results based on the matching score of the content associated with the results. For example, the smart suggestions engine 110 can increase a ranking of the results associated with content that has a higher matching score. Continuing the example above, the smart suggestion engine 110 can alter the ranking of the search results such that search results relating to content that includes associated tags indicating capabilities that are present on the mobile device 140 are ranked higher than search results relating to content that includes associated tags indicating capabilities that are not present on the mobile device 140. In some embodiments, the smart suggestions engine 110 can operate in the background, that is, provide the filtered search results without user intervention from the mobile device 140.

The server 102 further includes an application programming interface (API) 111 for interfacing between the smart content filter service 116, the smart suggestions engine 110, and the portal applications 108. Specifically, when the portal applications 108 employs (interface with) the smart content filter service 116, the smart suggestion engine 110, or both, the portal application 108 utilizes the API 111 when delivering content of the portal application 108 to the mobile device 140.

The illustrated environment of FIG. 1 also includes the mobile device 140, or multiple mobile devices 140. The mobile device 140 may be any computing device operable to connect to or communicate with at least the server 102 via the network 130 using a wireline or wireless connection. In general, the mobile device 140 comprises an electronic computer device operable to receive, transmit, process, and store any appropriate data associated with the environment 100 of FIG. 1.

The illustrated mobile device 140 further includes a client application 146. The client application 146 is any type of application that allows the mobile device 140 to request and view content on the mobile device 140. In some examples, the client application 146 includes a browser. The client application 146 includes a user agent profile generator 150. The user agent profile generator 150 generates the user agent profile (e.g. a string), which includes the capabilities of the mobile device 140. The user agent profile, and the capabilities, can be transmitted to the server 102 and stored by the device specific capabilities list 122, described further below. To that end, the sever 102 can determine, from the user agent profile (e.g., the string), the capabilities of the mobile device 140. For example, the user agent profile (e.g., the string) of the client application 146 with respect to the mobile device 140 can include:

Mozilla/5.0 (iPad; U; CPU OS 3_{—}2_{—}1 like Mac OS X; en-us)

AppleWebKit/531.21.10 (KHTML, like Gecko) Mobile/7B405

The illustrated mobile device 140 further includes an interface 152, a processor 144, and a memory 148. The interface 152 is used by the mobile device 140 for communicating with other systems in a distributed environment—including within the environment 100—connected to the network 130; for example, the server 102, as well as other systems communicably coupled to the network 130. Generally, the interface 152 comprises logic encoded in software and/or hardware in a suitable combination and operable to communicate with the network 130. More specifically, the interface 152 may comprise software supporting one or more communication protocols associated with communications such that the network 130 or interface's hardware is operable to communicate physical signals within and outside of the illustrated environment 100.

As illustrated in FIG. 1, the mobile device 140 includes a processor 144. Although illustrated as a single processor 144 in FIG. 1, two or more processors may be used according to particular needs, desires, or particular embodiments of the environment 100. Each processor 144 may be a central processing unit (CPU), an application specific integrated circuit (ASIC), a field-programmable gate array (FPGA), or another suitable component. Generally, the processor 144 executes instructions and manipulates data to perform the operations of the mobile device 140. Specifically, the processor 144 executes the functionality required to receive and respond to requests from the mobile device 140.

The illustrated mobile device 140 also includes a memory 148, or multiple memories 148. The memory 148 may include any memory or database module and may take the form of volatile or non-volatile memory including, without limitation, magnetic media, optical media, random access memory (RAM), read-only memory (ROM), removable media, or any other suitable local or remote memory component. The memory 148 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the mobile device 140. Additionally, the memory 148 may include any other appropriate data, such as VPN applications, firmware logs and policies, firewall policies, a security or access log, print or other reporting files, as well as others.

There may be any number of mobile devices 140 associated with, or external to, the environment 100. For example, while the illustrated environment 100 includes one mobile device 140, alternative implementations of the environment 100 may include multiple mobile devices 140 communicably coupled to the server 102 and/or the network 130, or any other number suitable to the purposes of the environment 100. Additionally, there may also be one or more additional mobile devices 140 external to the illustrated portion of environment 100 that are capable of interacting with the environment 100 via the network 130. Further, the term “client” and “user” may be used interchangeably as appropriate without departing from the scope of this disclosure. Moreover, while the mobile device 140 is described in terms of being used by a single user, this disclosure contemplates that many users may use one computer, or that one user may use multiple computers.

The illustrated mobile device 140 is intended to encompass any mobile computing device such as a wireless data port, smart phone, personal data assistant (PDA), tablet computing device, one or more processors within these devices, or any other suitable processing device. For example, the mobile device 140 may comprise a computer that includes an input device, such as a keypad, touch screen, or other device that can accept user information, and an output device that conveys information associated with the operation of the server 102 or the mobile device 140 itself, including digital data, visual information, or a graphic user interface (GUI) 142, as shown with respect to the mobile device 140.

Further, the illustrated mobile device 140 includes the GUI 142 to interface with at least a portion of the environment 100 for any suitable purpose, including generating a visual representation of a web browser. Generally, through the GUI 142, the user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, the GUI 142 can represent any graphical user interface, including but not limited to, a web browser, touch screen, or command line interface (CLI) that processes information in the environment 100 and efficiently presents the information results to the user. In general, the GUI 142 may include a plurality of user interface (UI) elements, some or all associated with a web browser, such as interactive fields, pull-down lists, and buttons operable by the user at the mobile device 140. These and other UI elements may be related to or represent the functions of the web browser. In particular, the GUI 142 may be used to view and navigate various web pages located both internal and external to the server.

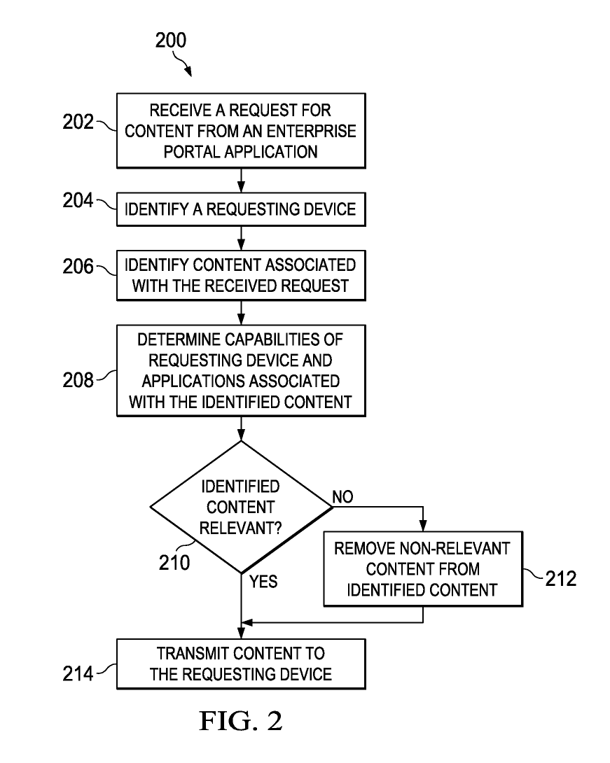

FIG. 2 illustrates an example method 200 for providing relevant content to a requesting mobile device. The example method 200 can be executed, for example, by the smart content filter service 116, using one or more computing devices. For example, the server 102, the mobile device 140, or both can be used to execute the example process 200 and obtain any data from the memory of the mobile device 140, the server 102, or both.

In step 202, a request is received for content from an enterprise portal application. Specifically, the server 102 can receive a request for content from the mobile device 140 via the interface 104. The request for content can include content from one or more of the portal applications 108. Further, the request for content from the mobile device 140 can include the client application 146 requesting content from the server 102. For example, a browser client application 146 can request display of content from the portal applications 108. Continuing the example above, the server 102 receives a request, from the mobile device 140, and specifically, the client application 146, for content from a portal mapping application 108.

In step 204, a requesting device is identified from the received request for content. In some examples, the mobile device 140 can transmit data to the server 102 that includes identification data of the mobile device 140, the identification data including, at least, capabilities of the mobile device 140. Specifically, the user agent profile generator can generate a user agent profile (e.g., a string) that includes the capabilities of the client application 146, the mobile device 140, or both. The server 102 receives the identification data and stores the identification within the device specific capabilities list 122 of the memory 112. In some embodiments, the request for content includes the identification data (e.g., the capabilities) of the mobile device 140, the client application 146, or both. In some examples, the server 102 can determine the identify (e.g., determine the capabilities of) the mobile device 140 based on the identification data sent by the mobile device 140 by comparing the identification data (e.g., a type of the mobile device 140) with the device specific capability list 122. Accordingly, the server 102 can determine the associated capabilities, if available, of the type of the mobile device 140.

In some examples, the identification data can include the internet protocol (IP) address of the mobile device 140. The server 102 can determine the associated capabilities of the mobile device 140 from the device specific capabilities list 122 of the memory 112 based on the IP address. In some examples, the server 102 can identify the capabilities of the mobile device 140 using any combination of the above-mentioned methods. In some embodiments, the mobile device 140 transmits the identification of the mobile device 140 to the server 102 in response to a request from the server 102 or automatically upon establishing a session with the server 102. In some embodiments, the server 102 stores the identification data of the mobile device 140 in the device specific capabilities list 122 of the memory 112.

In step 206, content is identified that is associated with the received request. Specifically, the server 102 can identify one or more portal applications 108 in response to the received request from the mobile device 140 and further, the server can identify content of one or more portal applications 108 in response to the received request from the mobile device 140. The portal applications 108, and further, the content of the portal applications 108 can be associated with a set of required capabilities of the requesting device (e.g., the mobile device 140), as mentioned above. Capabilities can relate to hardware of the device (processor, graphics, display, GPS, camera, wireless radio, etc.), software installed (a specific application), the operating system/version, brand of device, etc. The request content can be displayed information (such as using HTML 5), enhanced functionality associated with a GPS or camera, etc. Continuing the example above, the sever 102 identifies content from one or more portal applications 108, such as mapping applications and content from the mapping applications. The mapping applications can have the associated tag of GPS capability and browser version capability.

In step 208, capabilities are determined of the requesting device and of the applications associated with the identified content. For example, capabilities of the mobile device 140 and the capabilities of the portal applications 108 associated with the requested content can be determined by the smart content filter service 116. Specifically, the smart content filter service 116 receives the capabilities of the mobile device 140 (such as through identification information sent by the mobile device 140, through the device specific capability list 122, or both) and receives the capabilities of the portal applications 108 from the portal application data 118. The smart content filter service 108 compares (e.g., matches) the capabilities of the mobile device 140 with the capabilities of the portal applications 108 (e.g., the tags associated with the portal applications 108). The smart content filter service 116 matches the capabilities between the mobile device 140 and the portal applications 108. In some embodiments, the capabilities of the mobile device 140 are determined by, or in combination with, the web content sub-portions 175. For example, the smart filter service 108 receives the capabilities of the mobile device 140 from the web content sub-portions 175 that “wraps” the particular portal application 108.

Continuing the example above, the smart content filter service 116 determines that the capabilities of the mobile device 140 include, at least, a GPS capability. Further, the smart content filter service 116 determines that the requested content includes content from a portal application 108 that has the associated tag of GPS capability and browser version capability (e.g., a mapping application running within a particular browser version). The smart filter service 116 compares (e.g., matches) the capabilities of the mobile device 140 (e.g., the GPS capability) with the tagged capabilities (e.g., the tagged GPS capability and the browser version capability) of the requested portal application 108. In some embodiments, the requested portal application 108 can include other associated tagged capabilities in addition to the GPS capability and the browser version capability.

In step 210, it is determined whether the identified content (of step 206) is relevant to the mobile device 140. Specifically, the smart content filter service 116 determines whether content from the requested portal application 108 is relevant (e.g., able to be displayed by the mobile device 140) based on at least the comparison of the capabilities of the mobile device 140 and the capabilities of the portal application 108. Continuing the example above, the smart content filter service 116 determines whether at least a portion of the identified content from the portable application 108 (e.g., the mapping application) is able to be displayed by the mobile device 140 based on the aforementioned comparison.

In step 212, it is determined that at least a portion of the content is not relevant and the portion of the content is removed from the identified content. Specifically, the smart content filter service 116 determines that at least a portion of the content associated with the requested portal application 108 is unable to be displayed by the mobile device 140. For example, the content filter service 116 determines that a portion of the content of the portal application 108 is associated with a tagged capability that the mobile device 140 does not include. Thus, the mobile device 140 is unable to run (e.g., display) the content associated with the tagged capability. Accordingly, the content (e.g., the portion of the content) of the portal application 108 is modified based upon the aforementioned comparison. Specifically, the non-relevant content is filtered (e.g., removed) from the identified content for transmission to the mobile device 140. In some embodiments, the entire content of the portable application 108 is associated with a tagged capability the mobile device 140 does not include. Continuing the example above, the smart content filter service 116 determines that a portion of the content from the portal application 108 (e.g., the mapping application) is non-relevant to the mobile device 140 in that the portion of the content is associated with a tagged capability (e.g., the browser version) that the mobile device 140 does not include. Thus, this portion is not transmitted to the mobile device 140.

In step 214, the relevant content is transmitted to the requesting device. Specifically, the smart content filter service 116 transmits the remaining (relevant) portions of content from the requested portal application 108 to the mobile device 140. The remaining portions of content are relevant to the mobile device 140 in that the portions can be displayed (e.g., run) by the mobile device 140. In some implementations, in response to determining that at least a portion of the content is relevant, the portion of the content is transmitted to the mobile device 140. Specifically, the smart content filter service 116 determines that at least a portion of the content associated with the requested portal application 108 is able to be displayed by the mobile device 140. For example, the content filter service 116 determines that a portion of the portal application 108 is associated with a tagged capability that the mobile device 140 includes. Thus, the mobile device 140 is able to run (e.g., display the content of the portal application 108 associated with the tagged capability). Continuing the example above, the smart content filter service 116 determines that a portion of the content from the portal application 108 (e.g., the mapping application) is relevant to the mobile device 140 in that the portion of the content is associated with a tagged capability (e.g. GPS capability) that the mobile device 140 does include. Thus, this portion is transmitted to the mobile device 140.

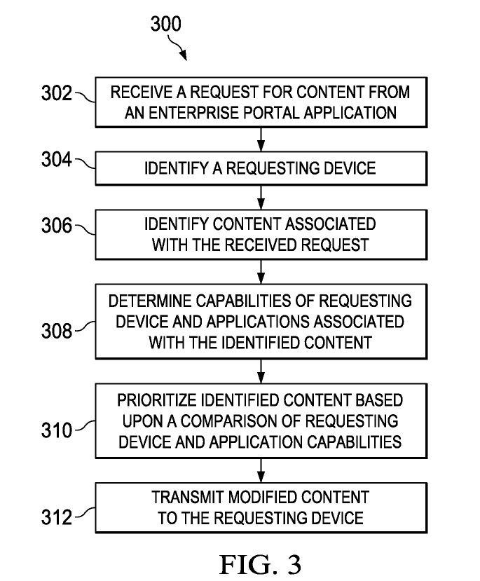

FIG. 3 illustrates an example method 300 for providing smart suggestions for content to a requesting mobile device. The example method 300 can be executed, for example, by the smart suggestions engine 110, using one or more computing devices. For example, the server 102, the mobile device 140, or both can be used to execute the example process 300 and obtain any data from the memory of the mobile device 140, the server 102, or both.

In step 302, a request is received for content from an enterprise portal application. Specifically, the server 102 can receive a request for content from the mobile device 140 via the interface 104. The request for content can include content from one or more of the portal applications 108. Further, the request for content from the mobile device 140 can include the client application 146 requesting content from the server 102. For example, a browser client application 146 can request display of content from the portal applications 108. Continuing the example above, the server 102 receives a request, from the mobile device 140, and specifically, the client application 146, for content from a portal mapping application 108.

In step 304, a requesting device is identified from the received request for content. In some examples, the mobile device 140 can transmit data to the server 102 that includes identification data of the mobile device 140, the identification data including, at least, capabilities of the mobile device 140. Specifically, the user agent profile generator can generate a user agent profile (e.g., a string) that includes the capabilities of the client application 146, the mobile device 140, or both. The server 102 receives the identification data and stores the identification within the device specific capabilities list 122 of the memory 112. In some embodiments, the request for content includes the identification data (e.g., the capabilities) of the mobile device 140, the client application 146, or both. In some examples, the server 102 can determine the identity (e.g., determine the capabilities of) the mobile device 140 based on the identification data sent by the mobile device 140 by comparing the identification data (e.g., a type of the mobile device 140) with the device specific capability list 122. Accordingly, the server 102 can determine the associated capabilities, if available, of the type of the mobile device 140.

In some examples, the identification data can include the internet protocol (IP) address of the mobile device 140. The server 102 can determine the associated capabilities of the mobile device 140 from the device specific capabilities list 122 of the memory 112 based on the IP address. In some examples, the server 102 can identify the capabilities of the mobile device 140 using any combination of the above-mentioned methods. In some embodiments, the mobile device 140 transmits the identification of the mobile device 140 to the server 102 in response to a request from the server 102 or automatically upon establishing a session with the server 102. In some embodiments, the server 102 stores the identification data of the mobile device 140 in the device specific capabilities list 122 of the memory 112.

In step 306, content is identified that is associated with the received request. Specifically, the server 102 can identify one or more portal applications 108 in response to the received request from the mobile device 140 and further, the server can identify content of one or more portal applications 108 in response to the received request from the mobile device 140. The portal applications 108, and further, the content of the portal applications 108 can be associated with a set of required capabilities of the requesting device (e.g., the mobile device 140), as mentioned above. Capabilities can relate to hardware of the device (processor, graphics, display, GPS, camera, wireless radio, etc.), software installed (a specific application), the operating system/version, brand of device, etc. The request content can be displayed information (such as using HTML 5), enhanced functionality associated with a GPS or camera, etc. Continuing the example above, the sever 102 identifies content from one or more portal applications 108, such as mapping applications and content from the mapping applications. The mapping applications can have the associated tag of GPS capability and browser version capability.

In step 308, capabilities are determined of the requesting device and of the applications associated with the identified content. For example, capabilities of the mobile device 140 and the capabilities of the portal applications 108 associated with the requested content can be determined by the smart content filter service 116. Specifically, the smart content filter service 116 receives the capabilities of the mobile device 140 (such as through identification information sent by the mobile device 140, through the device specific capability list 122, or both) and receives the capabilities of the portal applications 108 from the portal application data 118. The smart content filter service 108 compares (e.g., matches) the capabilities of the mobile device 140 with the capabilities of the portal applications 108 (e.g., the tags associated with the portal applications 108). The smart content filter service 116 matches the capabilities between the mobile device 140 and the portal applications 108. In some embodiments, the capabilities of the mobile device 140 are determined by, or in combination with, the web content sub-portions 175. For example, the smart filter service 108 receives the capabilities of the mobile device 140 from the web content sub-portions 175 that “wraps” the particular portal application 108.

Continuing the example above, the smart content filter service 116 determines that the capabilities of the mobile device 140 include, at least, a GPS capability. Further, the smart content filter service 116 determines that the requested content includes content from a portal application 108 that has the associated tag of GPS capability and browser version capability (e.g., a mapping application running within a particular browser version). The smart filter service 116 compares (e.g., matches) the capabilities of the mobile device 140 (e.g., the GPS capability) with the tagged capabilities (e.g., the tagged GPS capability and the browser version capability) of the requested portal application 108. In some embodiments, the requested portal application 108 can include other associated tagged capabilities in addition to the GPS capability and the browser version capability.

In step 310, the identified content is prioritized based upon a comparison of the requesting device capabilities and the application capabilities. Specifically, the smart suggestions engine 110 modifies the content provided by the portal application 108 such that the content is prioritized (e.g., in a search result listing). The smart suggestion engine 110 can modify the content by, for example, rearranging, prioritizing, or otherwise indicating the identified content, based on the aforementioned comparison. The modifications can be indicated by altering/adding order, color, sound, animation, boldness, etc., depending on the mobile device 140. In some embodiments, the smart suggestion engine 110 modifies (e.g., prioritizes) the filtered content provided by the smart content filter service 116. Continuing the example above, the smart suggestions engine 110 modifies (e.g., prioritizes) the content provided by the portal application 108 (e.g., the mapping application) based upon the aforementioned comparison provided by the smart content filter service 116. Specifically, the smart suggestion engine 110 can prioritize the content provided to mobile device 140 such that content related to the GPS capability is displayed prior to, or before, content that is related to other capabilities of the mobile device 140. In some embodiments, the smart suggestion engine 110 can prioritize the content provided to mobile device 140 such that content related to the GPS capability is displayed prior to, or before, content that is related to capabilities that the mobile device 140 does not include.

In some embodiments, the smart suggestion engine 110, can alter a search results listing by filtering (e.g., removing) search results related to content (e.g., content from the portal applications 108) based on the comparison provided by the smart content filter service 116. Specifically, the smart suggestions engine 110 can filter (e.g., remove) search results related to content that has an associated capability tag that the mobile device 140 does not include. In some embodiments, the smart suggestions engine 110 can alter a matching score of the search results related to the content. The smart suggestion engine 110 can alter the search results based on the matching score of the content (e.g., the portal applications 108) associated with the results. For example, the smart suggestions engine 110 can increase a ranking of the results associated with content (e.g., content from the portal applications 108) having a higher matching score. Continuing the example above, the smart suggestion engine 110 can alter the ranking of the search results such that search results relating to content that include associated tags indicating capabilities that are present on the mobile device 140 are ranked higher than search results relating to content that include associated tags indicating capabilities that are not present on the mobile device 140.

In step 312, the modified content is transmitted to the requesting device. Specifically, the server 102 transmits the modified content to the mobile device 140, and particularly, the client application 146.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the steps in these processes may take place simultaneously, concurrently, in parallel, and/or in different orders than as shown. Moreover, example environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. For example, other methods described herein besides or in addition to that illustrated in FIGS. 2 and 3 may be performed. Further, the illustrated steps of methods 200 and 300 may be performed in different orders, either concurrently or serially. Further, steps may be performed in addition to those illustrated in methods 200 and 300, and some steps illustrated in methods 200 and 300 may be omitted without deviating from the present disclosure. Accordingly, the above description of example implementations does not define or constrain this disclosure. Other changes, substitutions, and alterations are also possible without departing from the spirit and scope of this disclosure.

What is claimed is:

1. A computer-implemented method for providing relevant content to a mobile device, the method comprising:
receiving, using at least one computer, a request for enterprise portal application content;
identifying a requesting device from the received request;
identifying enterprise portal application content from at least one enterprise portal application associated with the received request;
determining capabilities of the requesting device; and
comparing the determined capabilities of the requesting device with the capabilities required by a particular enterprise portal application.

2. The method of claim 1, wherein the received request is from a mobile device.

3. The method of claim 2, wherein the received request contains data identifying the mobile device.

4. The method of claim 1, wherein the requesting device capabilities are determined using one or more self-contained web documents that each reference a Uniform Resource Locator (URL).

5. The method of claim 1, further comprising identifying the relevance of the enterprise portal content to the requesting device based upon at least one result of the comparison.

6. The method of claim 1, further comprising modifying the identified enterprise portal content based upon the comparison.

7. The method of claim 6, wherein the modification removes non-relevant content from the identified enterprise portal content.

8. The method of claim 6, wherein the modification prioritizes the identified enterprise portal content.

9. The method of claim 1, wherein the modification removes non-relevant content from the identified enterprise portal content, forming a relevant data subset, and then prioritizes the relevant data subset.

10. The method of claim 6, further comprising transmitting the modified identified enterprise portal content to the requesting device.

11. A computer-program product for providing relevant content to a requesting mobile device, the computer program product comprising computer-readable instructions embodied on tangible, non-transitory media, the instructions operable when executed to perform operations comprising:
receiving, using at least one computer, a request for enterprise portal application content;
identifying a requesting device from the received request;
identifying enterprise portal application content from at least one enterprise portal application associated with the received request;
determining capabilities of the requesting device; and
comparing the determined capabilities of the requesting device with the capabilities required by a particular enterprise portal application.

12. The computer-program product of claim 11, wherein the received request is from a mobile device.

13. The computer-program product of claim 12, wherein the received request contains data identifying the mobile device.

14. The computer-program product of claim 11, wherein the requesting device capabilities are determined using one or more self-contained web documents that each reference a Uniform Resource Locator (URL).

15. The computer-program product of claim 11, further comprising identifying the relevance of the enterprise portal content to the requesting device based upon at least one result of the comparison.

16. The computer-program product of claim 11, further comprising modifying the identified enterprise portal content based upon the comparison.

17. The computer-program product of claim 16, wherein the modification removes non-relevant content from the identified enterprise portal content.

18. The computer-program product of claim 16, wherein the modification prioritizes the identified enterprise portal content.

19. The computer-program product of claim 11, wherein the modification removes non-relevant content from the identified enterprise portal content, forming a relevant data subset, and then prioritizes the relevant data subset.

20. The computer-program product of claim 16, further comprising transmitting the modified identified enterprise portal content to the requesting device.

21. A computing system comprising one or more processors, one or more memories, and instructions stored on the one or more memories and executable by the one or more processors to perform operations comprising:
receiving, using at least one computer, a request for enterprise portal application content;
identifying a requesting device from the received request;
identifying enterprise portal application content from at least one enterprise portal application associated with the received request;
determining capabilities of the requesting device; and
comparing the determined capabilities of the requesting device with the capabilities required by a particular enterprise portal application.

22. The system of claim 21, wherein the received request is from a mobile device.

23. The system of claim 22, wherein the received request contains data identifying the mobile device.

24. The system of claim 21, wherein the requesting device capabilities are determined using one or more self-contained web documents that each reference a Uniform Resource Locator (URL).

25. The system of claim 21, further comprising identifying the relevance of the enterprise portal content to the requesting device based upon at least one result of the comparison.

26. The system of claim 21, further comprising modifying the identified enterprise portal content based upon the comparison.

27. The system of claim 26, wherein the modification removes non-relevant content from the identified enterprise portal content.

28. The system of claim 26, wherein the modification prioritizes the identified enterprise portal content.

29. The system of claim 21, wherein the modification removes non-relevant content from the identified enterprise portal content, forming a relevant data subset, and then prioritizes the relevant data subset.

30. The system of claim 26, further comprising transmitting the modified identified enterprise portal content to the requesting device.
